(19) United States
(12) Patent Application Publication
(10) Pub. No.: US 2007/0182670 A1
(43) Pub. Date: Aug. 9, 2007

(54) Display device having a circuit protection function

(75) Inventors: Toshimitsu Watanabe, Yokohama (JP); Nobuaki Kabuto, Kunitachi (JP); Mitsuo Nakajima, Yokohama (JP)

Correspondence Address: TOWNSEND AND TOWNSEND AND CREW, LLP, TWO EMBARCADERO CENTER, EIGHTH FLOOR, SAN FRANCISCO, CA, 94111-3834, US

(73) Assignee: Hitachi, Ltd., Tokyo (JP)

(21) Appl. No.: 10/684,062

(22) Filed: Oct. 10, 2003

(30) Foreign Application Priority Data
Jun. 16, 2003 (JP) 2003-170182

(51) Int. Cl. G09G 3/22

(52) U.S. Cl. 345/75.2

(57) ABSTRACT

To protect a high-voltage circuit in a field emission display, a configuration according to the present invention includes a high-voltage power supply circuit, a field emission display panel to which a voltage is supplied from the high-voltage power supply circuit, a data driver for supplying display data to the field emission display panel, and a current measuring circuit for detecting a current flowing from the high-voltage power supply circuit to the field emission display panel. An amplitude of an output supplied from the data driver to the field emission display panel is controlled according to a value of the current detected by the current measuring circuit.

### BACKGROUND OF THE INVENTION

The present invention relates to a luminance control technique in a display device using, for example, a field emission display (FED).

In a field emission display, for example, in such a display of SCE (Surface Conduction Emitting) type in which electronic sources are arranged in a matrix form, a current of a high-voltage power source is detected and a predetermined operation is conducted on a wavefront value of a circuit to drive SCE pixels with respect to a current value to resultantly suppress luminance. For example, patent articles 1, 2, and 3 describe luminance control in the display of SCE type.

For example, JP-A-1999-288248 (to be referred to as patent article 1 herebelow) discloses in pages 7 and 8 and FIGS. 1 and 6 that luminance is suppressed by controlling a voltage applied to a horizontal or vertical driving driver according to a signal from a driving power source section. Or, the article discloses suppression of luminance by reducing a high voltage from a high-voltage generating section. Or, the article discloses control of contrast and/or RGB signal levels in a digital processing section.

JP-A-2000-242217 (to be referred to as Patent article 2 herebelow) discloses in pages 7 and 8 and FIG. 1 that increase in consumption power and heat generation is prevented by controlling a voltage applied to a horizontal driving driver according to a luminance signal and/or an anode current from a high-voltage generating section.

JP-A-2000-310970 (to be referred to as Patent article 3 herebelow) discloses in page 9 and FIG. 1 control of an anode voltage control circuit according to a signal from an anode current measuring circuit.

### SUMMARY OF THE INVENTION

However, patent articles 1 to 3 disclose techniques of a field emission display of SCE type, not disclosing at all how to protect the high-voltage circuit in an MIM-type FED. Patent articles 1 and 2 describe control of a driver. However, since the FED is of the SCE type, a period of time to apply voltage is controlled. This is not suitable for the control of luminance, and it is likely that some pixels are not turned on in a part of a screen and hence picture quality is deteriorated. Since patent article 2 describes a technique not using an anode current from the high-voltage circuit, it is not possible to sufficiently protect the high-voltage circuit. Patent article 3 describes a technique to control the anode voltage control circuit, not the driver, and hence protection against an eddy current is not possible.

It is therefore a first object of the present invention to improve reliability of a display device using an MIM-type FED.

A second object of the present invention is to improve reliability of a display device.

To achieve the first object according to the present invention, there is provided a configuration according to a scope of the claims in which, for example, a mean anode current of a high-voltage power source supplying a high voltage to an anode of an MIM-type FED is detected. When the value of the mean anode current exceeds a fixed value, a voltage amplitude outputted from a scan driver connected to a scanning electrode of the FED is controlled to reduce a voltage between a data line and a scanning line of the FED to thereby limit a quantity of an electronic beam emitted to the anode. Or, a mean anode current of a high-voltage power source supplying a high voltage to an anode of an MIM-type FED is detected. When the value of the mean anode current exceeds a fixed value, a voltage amplitude outputted from a data driver connected to a data line of the FED is controlled to reduce a voltage between the data line and a scanning line of the FED to thereby limit a quantity of an electronic beam emitted to the anode.

When compared with the known techniques controlling the period of time to apply an applying voltage to the scan driver or the data drive, the configuration of the present invention controls the voltage amplitude to the driver. Therefore, a natural video display image can be retained in this display device as in a display device of CRT type.

To achieve the second object of the present invention, there is provided a configuration according to a scope of the claims in which, for example, the output control of the driver and video signal control by a microcomputer are used in combination with each other.

### BRIEF DESCRIPTION OF THE DRAWINGS

FIG. 1 is a block diagram showing a first embodiment of the present invention.

FIG. 2 is a block diagram showing a second embodiment of the present invention.

FIG. 3 is a block diagram showing part of FIGS. 4 and 5 of the present invention.

FIG. 4 is a block diagram showing a third embodiment of the present invention.

FIG. 5 is a block diagram showing a fourth embodiment of the present invention.

### DESCRIPTION OF THE EMBODIMENTS

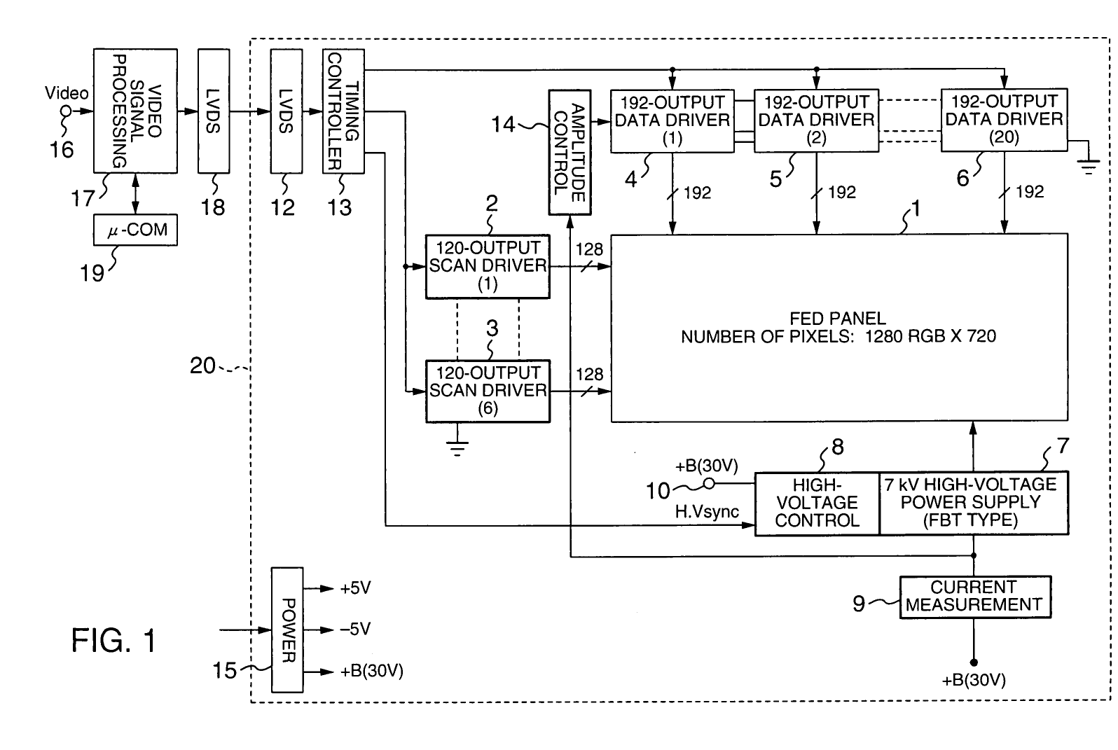

Description will now be given of an embodiment of the present invention by referring to the drawings. FIG. 1 shows a first embodiment of a luminance control section in a field emission display according to the present invention.

An FED panel 1 is a video display device of passive matrix type and includes data lines and scan electrode lines. The scan electrode lines are connected to scan drivers 2 to 3 and the data lines are connected to data drivers 4, 5, and 6. FIG. 1 shows an example of an FED panel including 1280×3 horizontal pixels and 720 vertical pixels. In this case, when 192-output LSI are used as data drivers, 20 LSI are required and when 128-output LSI are used as scan drivers, six LSI are required. The drivers are respectively indicated by circuit blocks 2 to 6 in FIG. 1. An anode terminal of the FED panel 1 is connected to a high-voltage power supply circuit 7, a high-voltage control circuit 8, and a current measuring circuit 9. A terminal 10 is a power source terminal. The scan drivers 2 to 3, the data drivers 4 to 6, the high-voltage power supply circuit 7, and the high-voltage control circuit 8 are connected via an LVDS (Low Voltage Difference Signaling) circuit 12, and a timing control circuit 13 to each other. The data drivers 4 to 6 are connected to an amplitude control circuit 14. An internal section in a frame of a dotted line indicates an FED module 20. A connector 15 is a power supply connector to the FED module 20. The FED module 20 is connected to a video signal input terminal 16, a video signal processing circuit 17, a microcomputer 19, and an LVDS circuit 18 to configure a video display device.

For a video signal inputted from the video signal terminal 16, the video signal processing circuit 17 conducts adjustment of, for example, an amplitude, a black level, and hue to send the signal via the LVDS circuit 18 to the LVDS circuit 12 of the FED module 20. The LVDS circuit has a function to convert a digital video signal at a transistor-to-transistor level (TTL) into a low-voltage digital differential voltage signal and vice versa and can propagate a signal without deterioration even when a signal line is elongated. The microcomputer 19 stores, for example, setting data to control the amplitude, the black level, and the hue in the video signal processing circuit 17 and controls the amplitude, the black level, and the hue. The video signal inputted to the LVDS circuit 12 is fed to the timing controller 13 to send signals and data respectively to the scan drivers 2 to 3, the data drivers 4 to 6, and the high-voltage control circuit 8 at respectively optimal timing. The data drivers 4 to 6 keep one-line data of the FED panel for one horizontal period to write new data at an interval of one horizontal period. The scan drivers 2 to 3 sequentially select scan electrode lines of the FED panel 1 in a vertical direction. For example, there is used a method in which a 0-volt voltage is applied thereto at active and a 5-volt voltage is applied thereto at non-active. When the scanning electrodes are selected, since a voltage of several kilovolt is applied from the high-voltage power supply circuit 7 to the anode terminal of the FED panel 1 according to output data from the data drivers 4 to 6, electron emission is conducted for each pixel and phosphor emits light by electron excitation to display one horizontal line of video. When the scan drivers 2 to 3 sequentially select the scanning electrode lines, one frame of video is displayed.

When a video image displayed on the FED panel 1 is bright, the quantity of a load current from the high-voltage power supply circuit 7 is large, and when the video image displayed on the FED panel 1 is dark, the quantity of a load current from the high-voltage power supply circuit 7 is small. The voltage value of the high-voltage power supply circuit 7 decreases as the load current increases. The high-voltage control circuit 8 conducts a control operation for high-voltage stabilization to keep the high-voltage value at a fixed value. To obtain brighter video display, the output amplitude of the data drivers 4 to 6 is increased. In a bright video display state, when a mean load current of the high-voltage power supply circuit 7 becomes excessive to be beyond a control range of high-voltage stabilization, there occurs failure, for example, the high voltage becomes lower and luminance decreases and/or the high-voltage circuit turns off and the video image cannot be displayed. Therefore, to prevent the excessive mean load current, the current measuring circuit 9 detects the means load current from the high-voltage power supply circuit by using, for example, a resistor. When the high-voltage current equal to or more than a fixed value flows, the amplitude control circuit 14 conducts control to suppress the output amplitude of the data drivers 4 to 6. In a specific control method, an external terminal is disposed to control a conversion gain of a digital-to-analog (DA) converter incorporated in each of the data drivers 4 to 6 to control the terminal. The control terminals are arranged in a cascade connection in the data drivers 4 to 6 to conduct desired control for all data drivers. By suppressing the amplitude, brightness of the displayed video image can be kept at a fixed value and hence the mean load current of the high-voltage power supply circuit 7 can be kept at a fixed value. In this case, since the video gain is controlled to fix the mean load current at a fixed value, luminance suppression in a high-luminance section (of peak luminance) in a small area of the displayed video image is reduced. Therefore, it is possible in any situation to display a video image with sufficient contrast. Since the voltage drop does not occur in the high-voltage circuit, it is possible in any situation to continuously display a bright video image. Since the phenomenon in which the high-voltage circuit turns off does not occur, the system is advantageous also in consideration of safety.

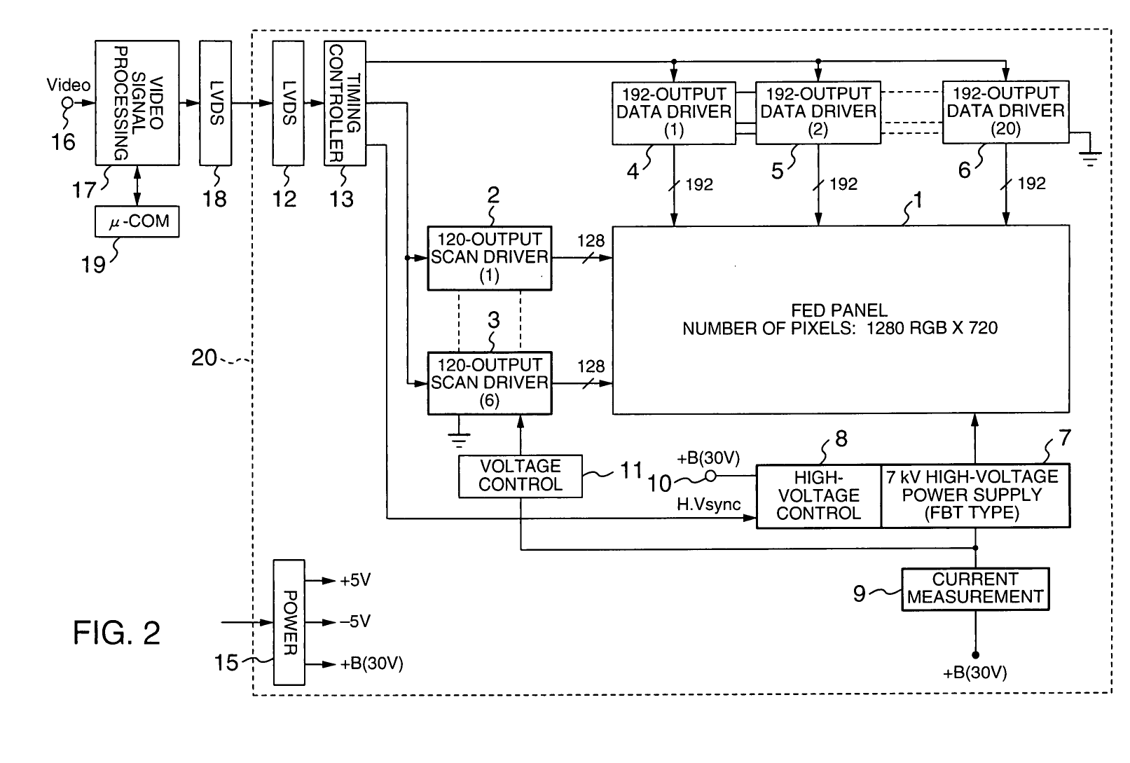

FIG. 2 shows a second embodiment of a luminance limiting section in an FED according to the present invention.

In FIG. 2, the same constituent components as those of FIG. 1 have the same functions and hence description thereof will be avoided. Description will be given of differences between FIGS. 1 and 2. While the amplitude control circuit 14 is a constituent component in FIG. 1, the amplitude control circuit 14 is not disposed in FIG. 2. A driver voltage control circuit 11 is added as a constituent component.

While the output amplitude of the data drivers 4 to 6 is controlled by the amplitude control circuit 14 in the first embodiment, the second embodiment operates as follows. The other operations are the same as those of the first embodiment, and hence description thereof will be avoided.

As a result of detection of a high-voltage current by the current measuring circuit 9, if it is detected that the high-voltage current exceeding a fixed value flows, the driving voltage control circuit 11 conducts control to set the selection voltage of the scan drivers 2 to 3 to a voltage value between the normal value “0 volt” to a value of the non-selection state “5 volt”. In a specific control method, when the scan driver is, for example, in a configuration in which a 5-volt voltage source is turned on and off by a MOS transistor, it is possible for the driving voltage control circuit 11 to control the voltage of the voltage source. The beam current of each pixel of the FED panel 1 is determined by a factor, namely, a potential difference between the scanning electrode line to which the voltage of the scan drivers 2 an 3 is applied and the data line. Therefore, by controlling the voltage for selection to change from 0 volt toward the voltage for non-selection, the beam current can be limited. As a result, the mean load current of the high-voltage power supply circuit 7 can be suppressed to a fixed value. In this case, since the video gain is controlled to set the mean load current to a fixed value, luminance suppression is reduced in a high-luminance section in a small area of the displayed video image. Therefore, a video image can be displayed with satisfactory contrast in any situation. Since the voltage drop does not occur in the high-voltage circuit, it is possible in any situation to continuously display a bright video image. Since the phenomenon in which the high-voltage circuit turns off does not occur, the system is advantageous also in consideration of safety.

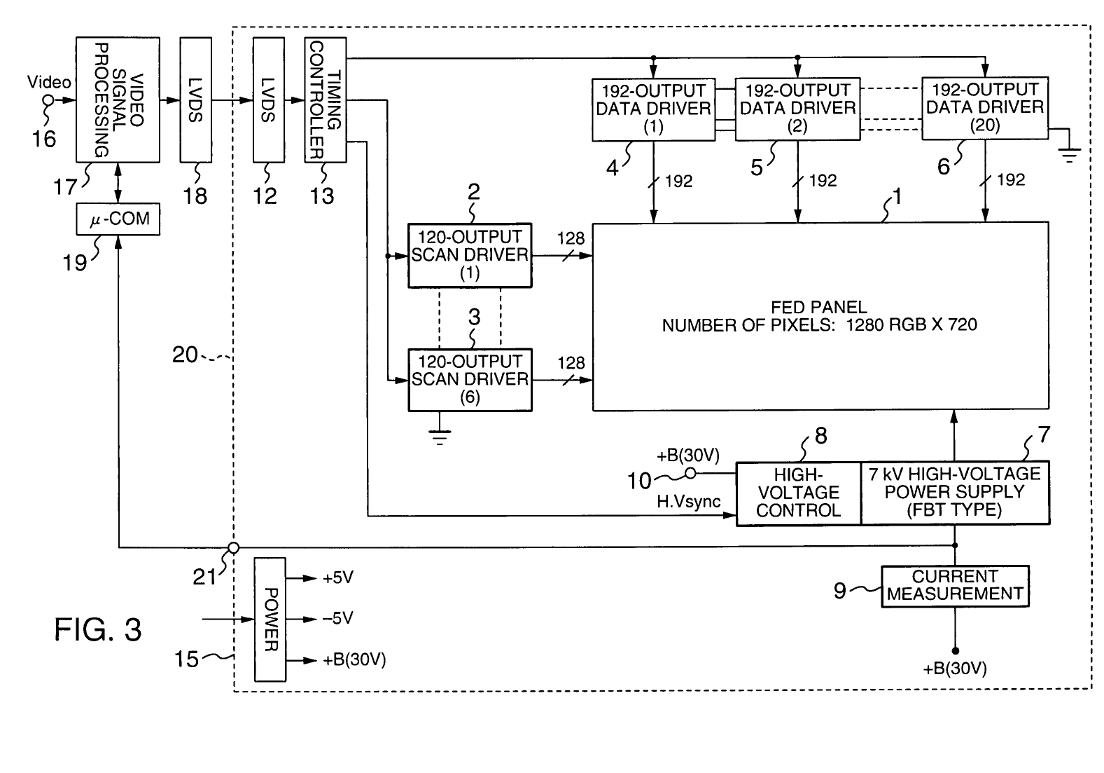

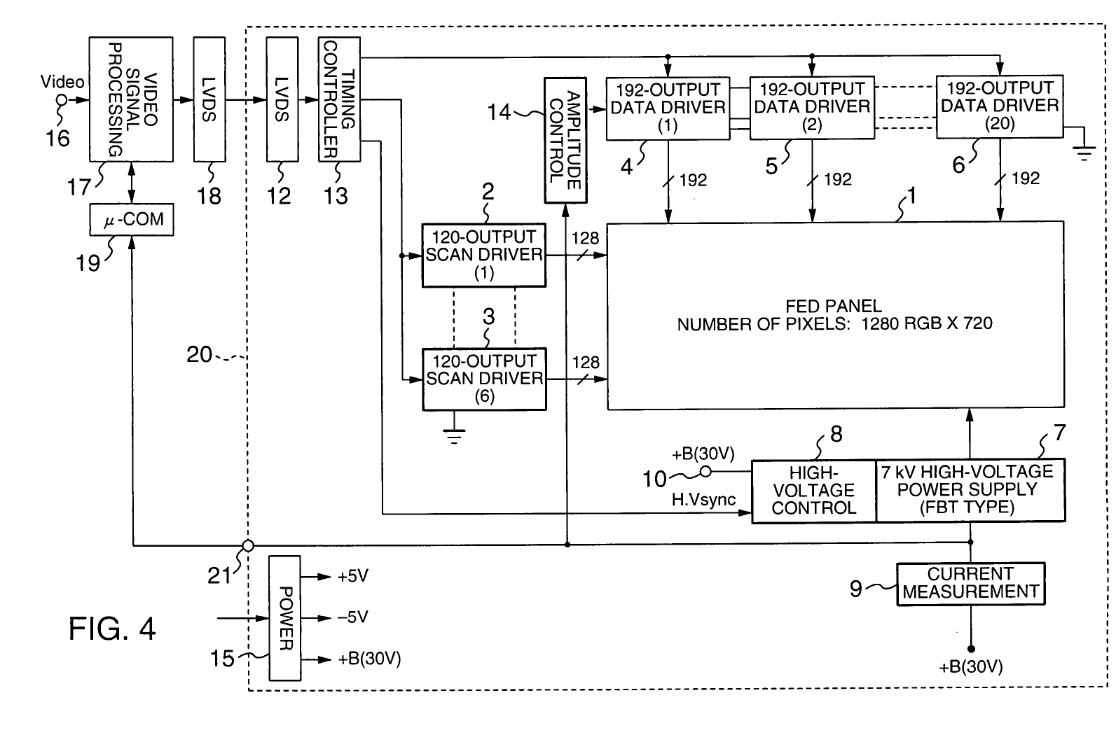

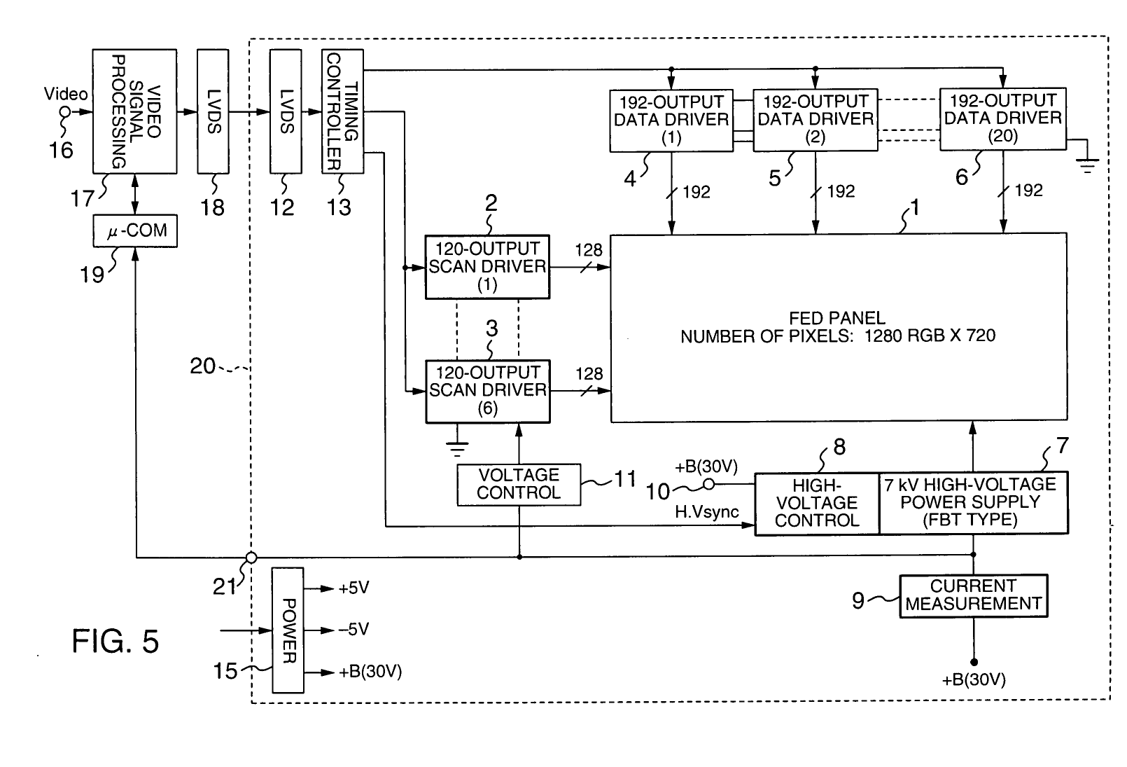

FIG. 3 shows luminance limitation by a microcomputer used as part of FIGS. 4 and 5.

In FIG. 3, the same constituent components as those of FIG. 1 have the same functions and hence description thereof will be avoided. Description will be given of differences between FIGS. 1 and 3. While the amplitude control circuit 14 is a constituent component in FIG. 1, the amplitude control circuit 14 is not disposed in FIG. 3. Signal lines from a terminal 21 and a terminal 21 to the microcomputer 19 are added as constituent components.

While the output amplitude of the data drivers 4 to 6 is controlled by the amplitude control circuit 14 in the first embodiment, the third embodiment operates as follows. The other operations are the same as those of the first embodiment, and hence description thereof will be avoided.

As a result of detection of a high-voltage current by the current measuring circuit 9, the detected signal is outputted from the terminal 21 to an external device of the FED module 20 to transfer the signal to the microcomputer 19. When the value of the detected current is equal to or more than a fixed value, the microcomputer 19 sets data such that the video signal processing section 17 reduces its contrast setting value. The video signal setting section 17 conducts control to reduce or to limit the signal amplitude of the video signal. In this case, the contrast setting value is kept retained until the microcomputer sets updated data again. By suppressing the signal amplitude as above, that is, by suppressing the mean brightness of the video display to a fixed value, the mean load current of the high-voltage power supply circuit 7 can be suppressed to a fixed value. In this case, since the video gain is controlled to set the mean load current to a fixed value, luminance suppression is reduced in a high-luminance section in a small area of the displayed video image. Therefore, a video image can be displayed with satisfactory contrast in any situation. Since the voltage drop does not occur in the high-voltage circuit, it is possible in any situation to continuously display a bright video image. Since the phenomenon in which the high-voltage circuit turns off does not occur, the system is advantageous also in consideration of safety.

FIG. 4 shows a third embodiment of a luminance limiting section in a field emission display according to the present invention.

In FIG. 4, the same constituent components as those of FIG. 1 have the same functions and hence description thereof will be avoided. Description will be given of differences between FIGS. 1 and 4. In FIG. 4, signal lines from a terminal 21 and a terminal 21 to the microcomputer 19 are added as constituent components. The basic operation is the same as that described in conjunction with FIGS. 1 and 3.

This embodiment differs from the other embodiments in that the amplitude control circuit 14 and the contrast control by the microcomputer 19 via the terminal 21 are both used. The amplitude control circuit 14 disposed in the FED module 20 is controlled for each line with respect to the data drivers 4 to 6. Therefore, when the video image is viewed for each video frame, there may occur unnatural feeling in some cases. By also using control of each frame of the video signal by the video signal processing circuit 17, it is possible to display a more natural video image and a bright video image in any situation. For example, by setting a control threshold value for the amplitude control circuit 14 to a value more than a control threshold value for the microcomputer, there can be obtained advantageous effect as follows. The contrast is controlled by the microcomputer 19 in an ordinary video display state. When the microcomputer 19 cannot control due to “latch up” because of, for example, discharge of the high-voltage circuit, the amplitude control circuit 14 controls the luminance to protect the high-voltage circuit.

The technique above is suitable in a case in which a TV signal is received to display an image thereof. However, in a case in which a PC signal is received from, for example, a personal computer, by conversely setting the control threshold value for the amplitude control circuit 14 to a value less than a control threshold value for the microcomputer 19, there can be obtained advantageous effect as follows. The contrast control is conducted by the amplitude control circuit 14 in an ordinary video display state such that a high-luminance character is not excessively bright, for example, in the screen display at disk operating system (DOS) activation, and the high-voltage circuit can be protected at the same time.

FIG. 5 shows a fourth embodiment of a luminance limiting section in a field emission display according to the present invention.

In FIG. 5, the same constituent components as those of FIG. 2 have the same functions and hence description thereof will be avoided. Description will be given of differences between FIGS. 2 and 5. In FIG. 5, signal lines from a terminal 21 and a terminal 21 to the microcomputer 19 are added as constituent components. The basic operation is the same as that described in conjunction with FIGS. 2 and 3. In this embodiment, the driving voltage control circuit 11 and the contrast control by the microcomputer 19 via the terminal 21 are both used. Since the driving voltage control circuit 11 disposed in the FED module 20 is controlled for each line with respect to the data drivers 2 to 3, all pixels of the scanning electrode lines selected by the control operation cause a black display phenomenon. Therefore, by also using the contrast control of the video signal by the video signal processing circuit 17, a more natural video image can be displayed and a bright video image can be displayed in any situation. For example, by setting a control threshold value for the driving voltage control circuit 11 to a value more than a control threshold value for the microcomputer 19, there can be obtained advantageous effect as follows. The contrast control is conducted by the microcomputer 19 in an ordinary video display state. When the microcomputer cannot conduct control due to “latch up” because of, for example, discharge of the high-voltage circuit, the driving voltage control circuit 14 conducts the luminance control to protect the high-voltage circuit.

Also in this embodiment, in a case in which a PC signal is received from, for example, a personal computer, by conversely setting the control threshold value for the driving voltage control circuit 11 to a value less than a control threshold value for the microcomputer 19, there can be obtained advantageous effect as follows. The contrast control is conducted by the driving voltage control circuit 11 in an ordinary video display state such that a high-luminance character is not excessively bright, for example, in the screen display at DOS activation, and the high-voltage circuit can be protected at the same time.

The embodiments described in conjunction with FIGS. 4 and 5 as above are not limited to the field emission display of MIM type, but are naturally applicable to a field emission display of SCE type. It is to be appreciated in this case that the control of drivers is not the control of the applying voltage amplitude but the control of time.

Since there exists a television (TV) set including a personal computer (PC) input terminal, it is desirable in the embodiments described for FIGS. 4 to detect whether the pertinent unit is used as a PC or as a TV set to respectively set two kinds of control values. When the unit is used as a PC, the control threshold values for the voltage control circuit 11 and the amplitude control circuit 14 are less than the control threshold value for the microcomputer 19. When the unit is used as a TV set, the control threshold values for the voltage control circuit 11 and the amplitude control circuit 14 are more than the control threshold value for the microcomputer 19.

The embodiments described in conjunction with the FIGS. 4 and 5 are not limited to the FED, but are naturally applicable also to other display devices.

The high-voltage circuit in the field emission display can be protected and reliability of the display device can be improved by the technique described above.

According to the present invention, reliability of the display device can be improved.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. A display device, comprising:
a high-voltage power supply circuit:
an MIM-type field emission display panel to which a voltage is supplied from the high-voltage power supply circuit;
a data driver for supplying display data to the field emission display panel; and
a current measuring circuit for detecting a current flowing from the high-voltage power supply circuit to the field emission display panel, wherein
an amplitude of an output supplied from the data driver to the field emission display panel is controlled according to a value of the current detected by the current measuring circuit.

2. A display device, comprising:
a high-voltage power supply circuit;
an MIM-type field emission display panel to which a voltage is supplied from the high-voltage power supply circuit;
a scan driver for scanning the field emission display panel; and
a current measuring circuit for detecting a current flowing from the high-voltage power supply circuit to the field emission display panel, wherein
an amplitude of a driver voltage supplied from the scan driver to the field emission display panel is controlled according to a value of the current detected by the current measuring circuit.

3. A display device, comprising:
a high-voltage power supply circuit;
a field emission display panel to which a voltage is supplied from the high-voltage power supply circuit;
a video signal processing circuit for supplying a video signal to the field emission display panel;
a data driver for supplying display data according to a signal from the video signal processing circuit to the field emission display panel; and
a current measuring circuit for detecting a current flowing from the high-voltage power supply circuit to the field emission display panel, wherein
an output supplied from the data driver to the field emission display panel is controlled when the current measuring circuit detects a first current value and the video signal processing circuit is controlled when the current measuring circuit detects a second current value.

4. A display device, comprising:
a high-voltage power supply circuit;
a field emission display panel to which a voltage is supplied from the high-voltage power supply circuit;
a video signal processing circuit for supplying a video signal to the field emission display panel;
a data driver for supplying display data according to a signal from the video signal processing circuit to the field emission display panel;
a scan driver for scanning the field emission display panel; and
a current measuring circuit for detecting a current flowing from the high-voltage power supply circuit to the field emission display panel, wherein
an output supplied from the scan driver to the field emission display panel is controlled when the current measuring circuit detects a first current value and the video signal processing circuit is controlled when the current measuring circuit detects a second current value.

5. A display device according to claim 3, further comprising first setting in which the first current value to be detected is larger than the second current value to be detected and second setting in which the first current value to be detected is smaller than the second current value to be detected.

6. A display device according to claim 4, further comprising first setting in which the first current value to be detected is larger than the second current value to be detected and second setting in which the first current value to be detected is smaller than the second current value to be detected.

7. A display, comprising:
a field emission display module including a high-voltage power supply circuit,
a field emission display panel to which a voltage is supplied from the high-voltage power supply circuit,
a scan driver for scanning the field emission display panel, and
a current measuring circuit for detecting a current flowing from the high-voltage power supply circuit to the field emission display panel, and
a video signal processing circuit for supplying a video signal to the field emission display module,
wherein an output from the scan driver is controlled according to a current value detected by the current measuring circuit and an output signal from the current measuring circuit is outputted from a terminal disposed in the field emission display module to be used by an external circuit, the external circuit driving the field emission display module.

8. A display device, comprising:
a field emission display module including a high-voltage power supply circuit,
a field emission display panel to which a voltage is supplied from the high-voltage power supply circuit,
a scan driver for scanning the field emission display panel,
a data driver for supplying display data to the field emission display panel, and
a current measuring circuit for detecting a current flowing from the high-voltage power supply circuit to the field emission display panel, and
a video signal processing circuit for supplying a video signal to the field emission display module,
wherein an output from the data driver is controlled according to a current value detected by the current measuring circuit and an output signal from the current measuring circuit is outputted from a terminal disposed in the field emission display module to be used by an external circuit, the external circuit driving the field emission display module.

9. A display device, comprising:
a high-voltage power supply circuit;
a display panel to which a voltage is supplied from the high-voltage power supply circuit;
a video signal processing circuit for supplying a video signal to the display panel;
a data driver for supplying display data according to a signal from the video signal processing circuit to the display panel; and
a current measuring circuit for detecting a current flowing from the high-voltage power supply circuit to the display panel, wherein
an output supplied from the data driver to the display panel is controlled when the current measuring circuit detects a first current value and the video signal processing circuit is controlled when the current measuring circuit detects a second current value.

10. A display device, comprising:
a high-voltage power supply circuit;
a display panel to which a voltage is supplied from the high-voltage power supply circuit;
a video signal processing circuit for supplying a video signal to the display panel;
a data driver for supplying display data according to a signal from the video signal processing circuit to the display panel;
a scan driver for scanning the display panel; and
a current measuring circuit for detecting a current flowing from the high-voltage power supply circuit to the display panel, wherein
an output supplied from the scan driver to the display panel is controlled when the current measuring circuit detects a first current value and the video signal processing circuit is controlled when the current measuring circuit detects a second current value.
